(19) United States
(12) Patent Application Publication
(10) Pub. No.: US 2006/0010086 A1
(43) Pub. Date: Jan. 12, 2006

(54) Data append method for sent postal mail

(76) Inventor: Elliot S. Klein, New York, NY (US)

Correspondence Address: COZEN O'CONNOR, P.C., 1900 MARKET STREET, PHILADELPHIA, PA, 19103-3508, US

(21) Appl. No.: 10/908,944

(22) Filed: Jun. 1, 2005

Related U.S. Application Data
(60) Provisional application No. 60/586,818, filed on Jul. 10, 2004.

(51) Int. Cl. G06F 17/00

(52) U.S. Cl. 705/410

(57) ABSTRACT

Method to manage an electronic interface by radio-frequency identification (“RIFD”) transponder to retrieve supplemental data for U.S. Postal Service sent mailings under non-negotiable privacy and digital identity registration policy standards, pursuant to data registration templates and self-certification standards.

### BACKGROUND OF THE INVENTION

The invention is a business method for creating and managing thousands, hundreds of thousands, or even millions of the contractual relationships required to protect the privacy of personal mailing information under U.S. law electronically. The business method makes U.S. Postal Mail more current and relevant by adding a small Radio Frequency Identification (“RFID”) tag or label, on letters or parcels, that provides private permission-based access to contracting parties that can supplement information for a physical mail recipient. The label affixed to a physical mailing acts to electronically access additional private data linked to sent mail, thereby presenting a mail recipient with optional appended communication disclosed and retrieved through an RFID tag in read-range proximity to RFID interrogator with TCP/IP connection.

The Postal Service protects the privacy and security of mail under a long-standing framework of federal statutes and regulations. The statutes and regulations specify strict safeguards for the cover, i.e., the envelope or wrapper, as well as contents of all mail sent through the postal system. These safeguards apply to the mail piece itself, its contents, and all information on its cover. This includes all information about the recipient that is contained on the mail piece. The Postal Service does not collect or store information that would allow the Postal Service to identify the recipient, except in accordance with these strict statutes and regulations. USPS active URL links to some current regulations are noted below, by example:
http://www.usps.com/cpim/ftp/hand/as353/apndx.html
http://www.usps.com/privacyoffice/intelligentmail.htm
http://www.usps.com/privacyoffice/_pdf/template.pdf

The inventive method provides secure access to supplemental private information related to the contents of postal delivery, packaging and transportation services over the Internet using Radio Frequency ID (RFID) transponder labels to append and/or add supplemental data links accessible over the Internet to a business or individual postal service mailing(s) or parcel(s).

Radio frequency identification, usually known as RFID, is composed of two main elements: an RFID “tag,” or “label” which is a microchip for information storage and an antenna, with an RFID reader or “interrogator” that can be set with frequency, format standards and security encryption policies to read communication information on the tag or launch additional secure data though an Internet Web browser when appropriately read with an RFID interrogator/reader from distances ranging from a few centimeters to several feet.

Generally, information on the tag can contain everything from a read-only unique identifier, such as an Electronic Product Code, to a continually updated history of a product, asset, or document to which the tag is attached. For purposes of this invention, the non-reusable RFID tag or label applied to a mailing wrapper does not contain direct supplemental text or other disclosure communications for postal customer access or viewing. Instead, it's only purpose is to grant access rights to additional data retrieved over the Internet (e.g., not by reading and generating supplemental information from the memory location within tags). The disclosure methods are predicated on the establishment and adherence of such industry standards as reader frequency, data formats, encryption keys and the formal agreement to contractual obligations with privacy terms between specific mailing parties.

The inventive method creates “Intelligent Mail” to provide additional business benefits that reinforce value of physical mail to consumers and businesses. Electronic forms of communication, such as electronic e-mail are reducing volume growth and value of physical postal delivery (sometimes called “Snail Mail”). Declining volumes from First Class, the postal service's most profitable mail rate, are considered a threat to the long-term financial stability of the USPS. This inventive method brings new value to physical mail for

Definition List 1

| Term | Definition |
|---|---|
| Contracting Parties | Specific sender(s) and associated recipient(s) of |
| | physical sent letter or parcel mail that have |
| | pre-agreed by contract to share and exchange private |
| | data. |

Contracting Parties and bridges the gap between physical mailings and electronic communications for new benefits to restore volumes. These processes can be operated independent of USPS to provide custom solutions for mailers, businesses and customers that tap into their own internal processing systems.

A business application example would be an inventor who receives written notice or Office Action from an Examiner by physical mail, with the instant invention affixed to the letter containing the Office Action. If the inventor and USTO were contractually enrolled with this novel self-certification standard for USPTO physical mail correspondence, he could then place the mailing envelope containing the Examiner's USPTO communication with said instant inventive RFID method and embodiments affixed to the USPTO sent mailing, in read range proximity of an appropriate RFID reader (with associated self-certification interface and pre-negotiated standards access template), and receive instant online, automatic and secure Web disclosures from the USPTO Private PAIR (Patent Application Retrieval System). This can facilitate secure access by the Inventor (or registered patent attorney/agent) to specific file contents and other supplemental USPTO communications data, without separately registering with the USPTO and obtaining a customer number, a digital PKI certificate to secure the transmission of the application to the USPTO, keying in a web address, digital signature protocols, patent application data or serial number, or having to downloaded special software to the inventor's Internet-connected PC. The self-certifying step to grant such permission(s) may be contained in the inventor's initial provisional application that can provide an appropriate contractual declaration permitting such disclosure methods in similar ways to current USPTO methods currently grant contractual permission under a power of attorney or other sworn statements to provide permission(s) to correspond through the appointment of an attorney or agent.

For implementation, a parcel service entity, such as the U.S. Postal Service, would sell low-cost RFID labels at retail service locations on printed self-adhesive sheets, that add embedded RFID wireless communication methods integrated into the label with photo, logo, text, or other graphic instructions, identification or descriptions individually printed on the label(s). Such labels would meet Postal Service requirements respecting placement on a mail piece and avoidance of interference with and facilitation of mail processing. While label may include pre-printed information on the small RFID label with the word “Append™” printed on label, to help sent mail recipient interface with the novel system, it can also feature designs without logo or text so plain label (e.g., single color tint, white or transparent) may be affixed or otherwise integrated onto front address surface area of envelope or mailing.

USPS would sell RFID labels or pre-printed RFID labeled envelopes much like regular postage stamps or postal merchandise (i.e., boxes, packaging materials, and other supplies) are sold today online or in Postal Service retail lobby or self-service vending kiosk locations to append and support integration with Intelligent Mail and Enhanced Package Services.

These are not traditional “postage” stamps, but simple stamp-sized adhesive certification labels encoded to application specific and certified common standards that provide a uniform method to append mailing data while protecting the customer's privacy, consistent with the “Privacy Act.”

Applying the self-adhesive RFID encoded labels enables customers themselves to achieve the supplemental private access information services they want under a certified standard endorsed by USPS (or other parcel service organization) to certification-standard for all its customers to apply to their own unique needs. Authorized electronic postage providers or a company affiliated with such providers, under conditions respecting postage revenue security approved by the Postal Services in accordance with 39 CFR part 501.1 may also distribute the non-postage RFID labels to end-customers.

While traditional postage stamp-like in size and self adhesive format, the labels are not postage stamps as regulated under TITLE 39, U.S. Code: POSTAL SERVICE. These special RFID labels carry no direct postal fees and provide no fee-based postal services. Labels would be printed and electronically encoded with unique, data encrypted identification standards for application to mailings and accessibility by registered customers.

Applications and data from reading the RFID is facilitated by link to Internet connected RFID reader or related RFID reader system that is independent of USPS. In this way, industry applications can be supported by the specific local application without customer data storage involvement by USPS.

USPS' only role is in setting the standard, providing and certifying labels it sells or helps support as being compliant for the service, including an affidavit that the application uses are to be compliant with the “Privacy Act,” or subsequent modification provisions that support the invention. In application, USPS does not store the data or provide services other than to create an open infrastructure for industry to utilize the benefits of the RFID label system and methods. These labels can either be encrypted for security and have the ability to read and write electronically to update data to the labels in real time as it is processed to select Internet connected LAN, Ethernet or PC-connected RFID reader application points. Even the RFID reader points do not need to be at postal service locations to create a functional industry service system.

USPS can work with RFID data standard organizations, software developers, public key encryption standards, RFID reader suppliers and other certified partners to support the Internet network and disclosure service applications described above.

### SUMMARY OF THE INVENTION

Method for creating and managing postal customer relationships between contracting parties under an electronic data append disclosure system, adding a label to physical mailing pieces with said contracting parties comprising postal mailing customers receiving data of customers and creating, using and disclosing private data of such customers in the ordinary course of business and enrolled self-certified partners requiring the use of said private data, said method comprising the steps of:
(a) assigning digital identities to the contracting parties,
(b) providing a postal customer RFID label having non-negotiable terms requiring observation of said data append with respect to said private data of a customer, and including provisions for contracting parties to certify adherence to said data append as self-certified covered entities or as self-certified business associates,
(c) providing an electronic interface accessible to said digital identities to facilitate negotiating and entering binding postal customer agreements between at least one self-certified covered entities and multiple self-certified contracting business associates pursuant to the terms of said RFID standards template, and (d) storing said agreements in an RFID standards database.

Preferably self-certification is accomplished either through a self-certification standard registration template for self-certification by electronic signature and storage in a separate self-certification database, or simply by inclusion of warranty clauses in the RFID standards. Preferably, digital identification and linking are accomplished through conventional database techniques, in which each node (entity represented in the master database) is identified, located, and represented though attribute synchronization, XNS, XRI and XDI-type web identity service, Unique ID (“UID”) Electronic Product Code (“EPC”) or analogous technology. Preferably the electronic interface includes interactive means for negotiating additional terms with respect to use or disclosure of said private data.

### STATEMENT REGARDING FEDERALLY FUNDED RESEARCH

This invention was not made under contract with any agency or branch of the United States Government.

### BACKGROUND OF THE INVENTION

Radio Frequency Identification (RFID) is a silicon chip-based transponder that communicates via radio waves. RFID has been commercially available for years, but the latest RFID developments now offer the compatibility with an express logistics, parcel service or other mail transport systems to enable improvements to postal and parcel services. The Presidential Commission on Postal Reform further identified the promise of considering RFID applications to improve mail with technology and novel applications to make mailing services more “intelligent” as described in the following URL links:
http://www.treas.gov/offices/domestic-finance/usps/docs/subcom/maynardbenjamin.pdf
http://www.ustreas.gov/offices/domestic-finance/usps/testimony-docs/Monahan.pdf

Today, Postal Service customers are using information gained from CONFIRM® and other USPS barcode services to augment their market and business processes over the Internet.

The issues of privacy associated with Government services, RFID “spy ware” technology applications and specifically the U.S. Postal Service, have, in part, prevented adoption of new Internet and related technology innovations that could enable electronic RFID service applications at the USPS and other mailing Industry application areas.

Application of low-cost RFID to mailing or parcels provide supplemental track and confirm enhancements can provide for an unlimited number of internal business and customer facing processes. Importantly, these processes can be independent of USPS to provide custom solutions for mailers that tap into their own internal processing systems.

Mail customers need branches to Intelligent Mail, Customer Gateway and Payment Systems. This new Business method for creating and managing postal mailing relationships electronically by appending mailings with electronic RFID certification label services improve over the prior art because they serve to:
Collaborate Between Industry and USPS
Provide Cost Savings Gained through Efficiencies
Increase Ease of Use for Postal Services
Expand Access
Enhance Revenue Opportunities
Support Process Improvements
Ensure Customer Privacy
Provide Stimulus for Mail Volume Growth

Using USPS as a trusted source for privacy provisional protection and standards can be leveraged as an important benefit since one of the key advantages of the inventive system is individual customer data would never be maintained or accessible by USPS. Everything is run by the end-customers themselves that are responsible for data integrity, RFID readers, customer support and processes. USPS only sells the “Smart Stamp” RFID label as a facilitating product for the USPS businesses, retail customers and the mailing Industry to custom utilize with trust and confidence. That makes the proposed method a simple and elegant solution for USPS to quickly launch or pilot the service.

Under the invention, USPS acts as the facilitator and common access point for anyone to purchase the RFID labels made to a common industry certified standard such as frequency, read-range, encryption format, standard field area(s) with unique ID number permanently encoded plus unique ID and/or Internet link to other internal corporate database applications.

Customers involved with contract provisions, and other internal (i.e., non-USPS) track & trace applications can utilize these new methods to achieve applications that link with or serve to complement USPS and other mailing services that have not been feasible with the prior art.

One of the first applications of RFID in a postal and express courier network is described in U.S. Pat. No. 6,259,367 titled “Lost and Found Systems and Methods” issued in 2001 to Elliot Klein, the same applicant and inventor as this instant invention. This patent describes, in part, how courier shippers can apply RFID and other Internet methods to create a ‘lost and found’ system to return missing property to their rightful owners.

Other system and methods to secure transfer of data between a workstation connected to a private network and a remote computer connected to an unsecured network are described in U.S. Pat. No. 5,864,683 issued to Boebert, et al. The Boebert patent does not teach the use of RFID transponders or their application to physical postal mailings for limiting access or disclosure rights.

Similarly, U.S. Pat. No. 5,867,667 issued to Butman, et al., titled “Publication network control system using domain and client side communications resource locator lists for managing information communications between the domain server and publication,” but does not teach application of RFID transponders or their combined linkage to U.S. postal mailings to manage private information communication.

As one example, U.S. Pat. No. 6,463,416 discloses an authentication system for identification documents. However, the prior art does not anticipate or suggest an original storing of a privacy protected RFID label association linkage with the documents that can be used to identify which trusted authenticating individual sent the document or package and the data appended to the document or package by RFID label linkage, or develop automated processes which utilize the appended RFID linked data as a way of authenticating the access and permissions to related data. Further, the process does not vision use of the U.S. mail or related USPS registration process to include and authenticate unique identity data such as appended data to a letter or package cover or wrapper which may be subsequently associated with the sender or recipients of the mail through the RFID tag as either hidden data stored in the tag or accessible on a controlled permission basis over an Internet network. Further, the process does not envision the use of a unique RFID code on a document to facilitate the development of business processes that can use the RFID code to provide authenticated access to appended data. In addition, U.S. Pat. No. 6,463,416 neither anticipates nor suggests employing an RFID label to a mailing item to append information related to that mailing item's contents or communication. A search of known patents covering RFID show none relevant to the development of a unique RFID label applied to mail or packages that can be used to provide supplemental communications using the system and methods claimed.

United States Patent Application Serial No. 2004/0015432 (“application 5432”), entitled “Business method for creating and managing multilateral contractual relationships electronically and on a large scale,” discusses protected health information by assigning digital identities to the contracting parties, providing a self-certification standard affidavit template enabling the contracting parties to achieve self-certification, and providing an electronic interface over the Internet to facilitate negotiating and entering binding multilateral contractual agreements between the parties pursuant to the terms of the affidavits. In this application, the use of DNA with the individual birth registration process and the subsequent distribution of such authenticated identity data by a state or local registrar when printing a certified copy of a birth record uniquely identified with the RFID tag embedded on the birth certificate document.

United States Patent Application Serial No. 2002/0005774 (“application 5774”), entitled RFID Tag for Authentication and Identification, neither discloses nor anticipates the use of the RFID tag to presenting rights similar to a self-certified privacy policy whereas certain alternate preferred embodiments of the method of the present invention provides a structure of an RFID tag that can identify the mailing parties to a privacy standard and agreed upon policy that (1) permits supplemental data appended to the U.S. mail or other parcel shipment to be accessed over the Internet (2) provides for a digital RFID label to serve as the gateway and link to supplemental appended data. Furthermore, United States Patent Application Serial No. 2002/0005774 does not teach use of an RFID label as is included within the preferred embodiments of the method of the present invention.

No processes are known adapting the use of RFID labels as a means to append supplemental data to a mailed letter or parcel for the purpose of uniquely identifying an instance of first verifying the parties have digitally agreed to a privacy policy and self-certified standard prior to being permitted access to the supplemental appended data. Additionally, no processes are known where mailing parties embed or attach RFID tags uniquely identifying data appended to the mailed item(s) on a self-certified permission basis whereby such unique RFID label enables third parties to confirm their permission to access the data referenced from the RFID tag on the sent letter or parcel. No known processes exist which enables mailing parties (i.e., the sender and recipients of a letter or package) to utilize the RFID tag as a means of self-certifying agreement to a policy for disclosing of the appended data linked from the RFID label on the letter or parcel. The invention utilizes the development of an RFID label schema to uniquely identify the entities sending and/or receiving the mailed item(s), the unique instance of each RFID label attached to the shipment(s), the data related to each unique instance of a shipment(s), and a process uniting other parties involved in a document workflow when such third party automated processes utilize the industry standard linkage stored in the RFID tag to read, write and store data stored in the tag or available on a network. The net effect of the invention is to provide powerful supplemental communication and processes that extend beyond the physical mail contents directly contained in the package or letter communication and to expand the role of U.S. mail in commerce and electronic forms of communications.

### DETAILED DESCRIPTION OF THE INVENTION

The business method uses conventional web hyper linking and database technology to create a hybrid affiliate network in which each node (entity represented in the master databases) is identified, located, and represented through attribute synchronization, XNS, XRI and XDI-type web identity service, or analogous technology. Examples include http://www.xns.org and http://www.oasis-open.org/committees.xri. The electronic contract component of the system can be satisfied by any of the following three methods: (1) an exchange of messages via e-mail, or paper; (2) the actions of electronic agents (software programmed to initiate or respond to electronic message offers); or (3) using website forms accepted by return message.

1. The first master database offers a standardized form registration (or similar legally binding privacy protection document, such as an Unsworn Declaration under Penalty of Perjury under 28 U.S.C. sctn.1746) that has the effect of permitting the person signing it to self-certify compliance with the data append provisions.

2. Entities signing the registration are assigned a digital identity and locator enabling rapid identification and location both of the entity and of any information linked to that entity in the system. Links may be multilateral or bilateral within the system.

3. One or more standardized legal “offer(s)” to enter into one or more standardized, multilateral RFID Data Append Agreement (“RFID standards”) incorporating the requirements of the standardized self-certifying business partner, but configured to permit additions, modifications, or alterations electronically that leave the legal requirements for self-certifying party set out in the RFID data append format intact.

4. Each of these legal forms is presented to system users by a web page or similar interface linked to a database, and in an order that permits legal “offer(s)”, negotiations between or between some or all the parties, and legal “acceptance” of agreed upon terms.

5. Someone accessing the “self-certifying” web page can use an electronic signature or other Secure Socket Layer (SSL) digital certificate or other legally binding mechanism (such as a paper registration faxed to the operator and imaged into a database) to “sign” the registration, which is stored in the database, and available to anyone searching it.

6. Anyone who has “self-certified” compliance with the data appends by signing the “self-certification” registration can then access the RFID standards web page, which presents the standardized, postal customer(s) as part of a legal “offer” that can be legally “accepted”, once again, via electronic signature, SSL certificate, electronic signature or other legally binding mechanism, such as a paper signature, to create an electronic or conventional contract.

7. The RFID standards itself recites (among other things set out in more detail below) that the legal “consideration” for a covered entity's agreement to send or include a USPS “data append” RFID label or other mailing authority to a business associate is the business associate's agreement to become and remain compliant with the data appends (and any other applicable regulations), and to comply with the terms and conditions of the current USPS Privacy Policy and/or the “Privacy Act.”

8. The RFID standard is designed to permit additions, modifications, or alterations by the parties, provided they do not impair the legally required components of the RFID standards.

9. Once a party has legally “accepted” the legal “offer”, and has “signed” the multilateral RFID standards (via electronic signature or other means), he or she is bound to its terms and conditions with respect to all other parties entering into the RFID standards as an electronic or conventional contract. This enables a binding, multilateral electronic or conventional contractual relationship between multiple parties with a single signature per party, or with fewer signatures per party than a system of bilateral exchanges of paper contracts or representative warranties would require.

10. If the party has added terms and conditions to the multilateral RFID standards, however, other contracting parties will not have contracted under the RFID standards with respect to that party until they have specifically indicated their agreement to the additional terms and conditions via electronic signature or other legally binding mechanism.

11. The “self-certification” database will be linked to the RFID standards database to ensure that all contracting parties self-certified themselves USPS compliant under USPS security, regulation and compliance under penalty of perjury.

12. The RFID standards is designed to be multilateral, and enables creation and management of contracts between multiple parties without the detailed and expensive “fine-tuning” required in a one-to-one, bilateral conventional contract. If every party insists on customizing the RFID standards, it will increase the burden of contracting as well as the complexity of the system, but the multilateral system still will operate far more quickly than a bilateral or multilateral paper contractual regime. In addition, retrieval, modification, and updates of existing contracts are greatly facilitated by the multilateral system.

### DRAWINGS

The invention will be better understood by reference to the following description, taken in connection with the accompanying drawings, in which:

FIG. 1 is an entity/relationship diagram of a prior art method of establishing postal customer relationship regarding privacy of a customer's private data, that uses printed barcodes to append the mail.

FIG. 2 is a similar entity/relationship diagram of the method of creating and managing a postal customer relationship regarding privacy of a customer's private data in its simplest form according to the present invention, and

FIG. 3 is a similar entity/relationship diagram of the method of creating and managing a postal customer relationship regarding privacy of a customer's private data, providing for self-certification through an Internet-based RFID tag registration standard that provides for specific spectrum frequencies and data format template requirements to enable universal RFID label data encoding and reading that conform to a set of standards, and providing for affixing a RFID label to a letter or package to append the contents of said mailing with enhanced privacy protection and customer specific RFID data applications.

FIG. 4 is a diagram of the RFID document generation function of FIG. 3.

FIG. 5 is a diagram of the client computer functions of FIG. 3.

FIG. 6 is a diagram of the de-obfuscating function carried out by the client computer of FIG. 3.

### DETAILED DESCRIPTION OF THE PREFERRED EMBODIMENT

The present invention will be described in greater detail with respect to the preferred embodiment with reference to the drawings so as to exemplify the invention. Various alternatives, refinements, and substitutions should become readily apparent based on the principles of the invention illustrated herein.

Diagrammatic Illustration of the Invention

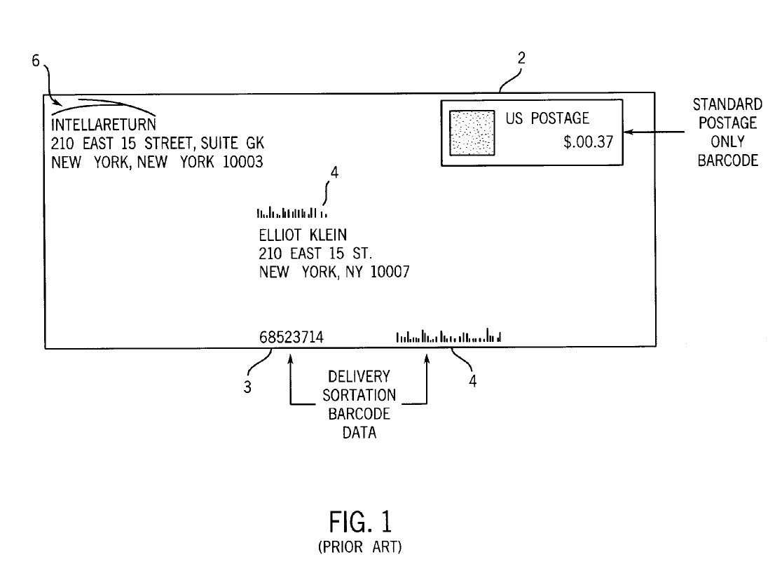

FIG. 1 Illustrates in its most general form, the prior art on an envelope specimen that includes a two-dimensional bar code for the postage indicia 2 and delivery sorting code number 3 and single bar code data 4 all used to track and provide linkages to the mail.

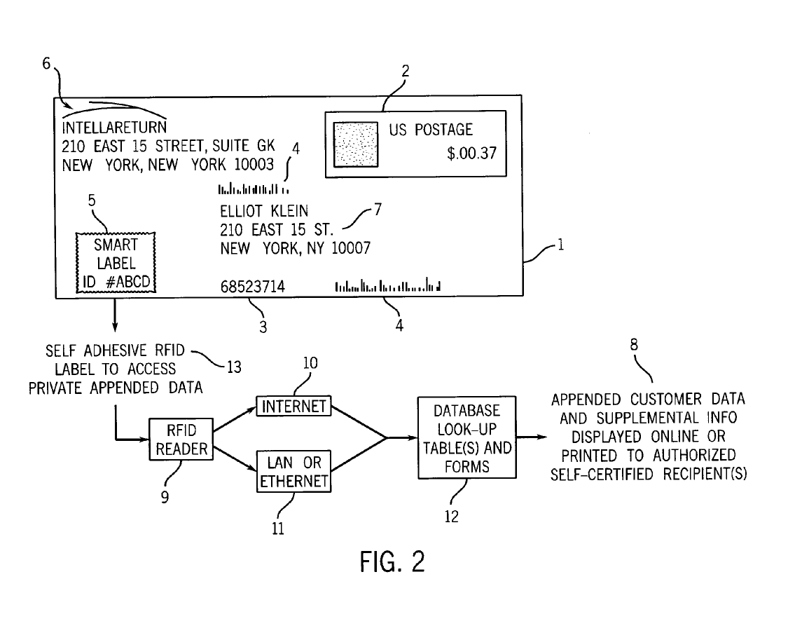

FIG. 2 illustrates how the application of an RFID label transponder 5 (“smart label”) creates a new entity/relationship diagram of the present invention. One of many customers 6 discloses personal information to one of many covered entities 7, such as an individual mailing recipient or business address location. The customer's personal information is enhanced by the covered entity to become enrolled self-certified partners, recorded and stored as a link to the appended data 8 that is in turn linked by RFID reader 9 through the Internet 10 or LAN/Ethernet connection 11 to a database lookup table 12 by the covered mailing entities 6 and 7. Such method illustrates the means to provide a self-certification standard registration template enabling the contracting parties (i.e., mailing entities) to achieve self-certification, and providing an electronic interface over the Internet 10 to provide and add supplemental data 8 communication to postal service mailings and parcel services pursuant to self-certification terms of agreed RFID label standards and associated data privacy template 12 electronically linked by wirelessly reading self-adhesive RFID data label 5 in accordance with RFID reader prior art.

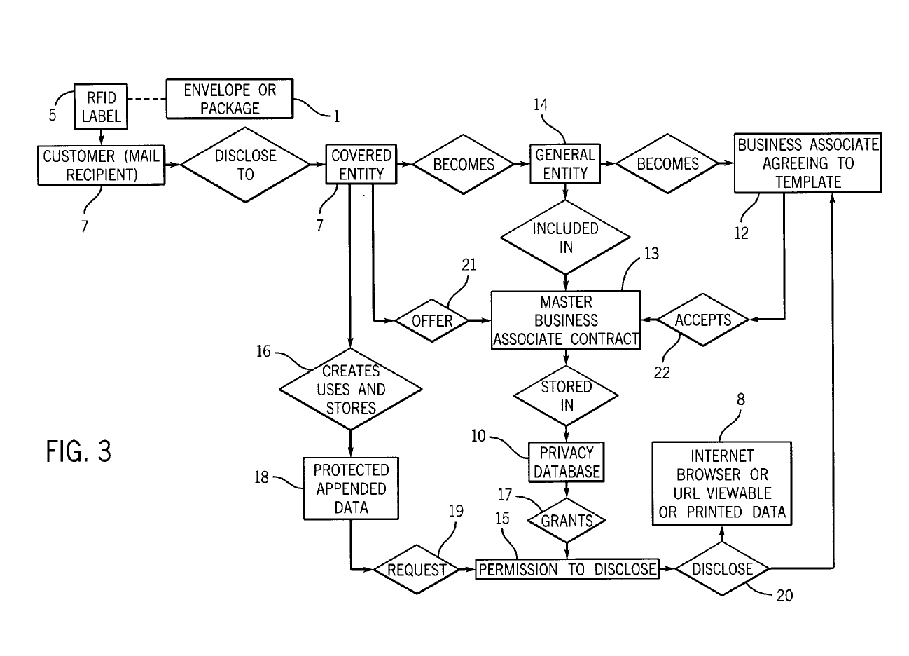

FIG. 3, in accordance with the present invention, one of many covered entities 7 and one of many business associates indicated at 12 are assigned digital identities and enter into a multilateral Master Business Associate Contract 13, the terms of which are available uniformly to other covered entities and to other business associates. The Master Business Associate Contract covered entity 14 preferably includes both negotiable and non-negotiable terms. From the standpoint of this application, the most relevant non-negotiable terms are the Privacy Standards required for access or related viewing, printing or other display of appended data 8 by the customer 7 through an Internet browser or URL 8 linked from reading the RFID label 5.

The invention also provides means for certification by the contracting parties of adherence to the Privacy Standards 10. This may simply be an acceptance agreement clause in the Master Business Associate Contract, and is shown in FIG. 3, wherein either a covered entity or a business associate becomes one of many certified entities 15 by agreeing to the Master Business Associate Contract. FIG. 3 also assumes no negotiation of special terms, and a simple offer and acceptance of the privacy terms contract. A completed contractual relationship between parties is stored as a record in a database 10. This record grants 17 permission 15 or first requests 19 and then may disclose 20 privacy protected supplemental data to a certified contracting business associate 12.

A preferred form of the invention is shown in FIG. 3, where a digital identity is assigned to an entity 7 upon self-certification and the digital identity is stored in a separate self-certified database 10. The Master Business Associate Contract contains both negotiable terms 21 and non-negotiable terms 22. Should the negotiation culminate in an agreement, the record of such agreement is stored in the Master Business Associate database 13.

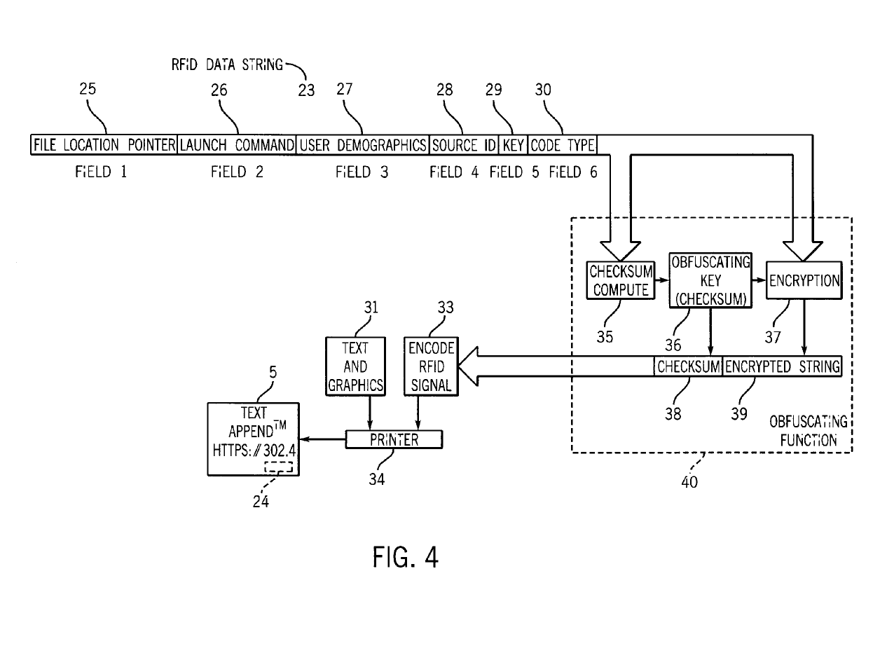

FIG. 4 further shows a system for generating and reading an intelligent tag or label 5 illustrated in block diagram form. The system comprises an intelligent tag or label generation system, which encodes, assembles and prints an intelligent tag or label 5 for subsequent radio frequency-reading in conjunction with a sent letter envelope, postcard or parcel linked to a client computer.

The system 40 for generating and reading an intelligent tag or label 5 comprises an intelligent tag or label generation system 33, which encodes, assembles and prints 34 an intelligent tag or label 5 for application to a letter's envelope or parcel for subsequent radio frequency-reading (RFID) following checksum compute 35, obfuscating key 36 and encryption 37 reading of data in conjunction with a client computer.

In operation, a vendor who wishes to provide an intelligent ID label or tag 5 programs certain parameters into an RFID data string 23 which will be encoded within a radio frequency-readable code 24 and printed on the tag along with text 31 or graphics 32. The document provides for additional data to be made available, under certain agreed upon conditions, that append the communication associated with the RFID tag affixed to the letter or parcel mailing. The document may be a small RFID label with printing that informs the mail recipient of options to receive supplemental appended data or how to obtain optional protected access to the RFID linked data once the letter or package is received

RFID has several advantages over bar code labels in that there are no optical considerations and therefore the RFID tags will read through low cost RFID readers placed near the mail or package tag, without a decrease in performance. RFID eliminates common problems associated with bar code such as ability to change data, and read/write RFID provides the benefit of the ability to securely add, change or update data.

As known in the prior RFID tag, it is common for an Inductive RFID label 5 to consist of silicon, a coiled, etched, printed, or stamped antenna, a capacitor, a substrate, and may include a protective covering as well as an encapsulating sealant. Newer RFID labels can be printed with conductive ink compositions such as is described in Patent Application 2004/0144958. Using capacitive coupling, electric fields are linked to and from a reader and tag. As in an inductive system, the RFID reader/writer generates an excitation field that serves as both the tag's source of power and its master clock. The tag cyclically modulates its data contents and transmits them to the reader's receiver circuit. The reader demodulates and decodes the data signal and provides a formatted data packet to a host computer for further processing.

Tags are printable by a label converter using standard industry methods. Electrodes can assume virtually any size and shape, enabling the adaptability of postage stamp-sized RFID tags using existing label or envelope printing papers. The RFID silicon is simply attached or embedded onto the printed substrate

Parameters to be included within the radio frequency-readable code depend upon the application desired by the vendor or standards. Referring now to FIG. 4, illustrates fields 1-6 of the RFID data string 23, may comprise a file location pointer 25, a launch command 26, a user identification field 27, a source identifier 28, an encryption key 29, and/or a code type field 30. For example, if the vendor wants the end-user to be able to access the vendor's Web site automatically upon reading the radio frequency ID information 24, then the parameters included in the radio frequency-readable tag may include the launch command 26 to launch an Internet browser application, such as a Uniform Resource Location (URL) code into the file location pointer 25, such as http://www.append-data.com. A printer 34 then utilizes the encoded data and desired text and graphics to print an intelligent document 5 for application onto the letter envelope, postcard or package's external surface. The RFID data string 23 may also be obfuscated 36 for privacy and security purposes, which will be described in detail below.

The intelligent document 5 is disseminated to the end user in accordance with the methods desired by the vendor. The vendor may be the seller of the tag or may be a sender of the object itself, in which case the tag may be affixed to the object before, at, or after it is sent to the recipient, and the unique identification number printed on or encoded within the RFID tag 5 can be pre-programmed.

For example, the mailing may be a single page letter from the re-election campaign of U.S. President George W. Bush requesting support for his political election campaign. The recipient of the simple letter mailing may have already registered under the instant method or can agree, subsequent to receipt of the physical mailing, to privacy terms and have the option to join the Republican party or otherwise agree to receive supplemental information about the local election event(s) and/or agree to receive a more detailed and current outline of the Republican party's statement of policies and/or schedule details for local community events in the recipient's home town community zip code or state by agreeing to privacy terms. In this way, the mail recipient can learn more and self-certify to receive supplemental appended data only if he or she wants. The advantages to this method include postage savings for the President Bush re-election campaign. Additionally, the intended recipient does not have to read through a long letter about the Republican Party if the recipient is not interested or does not want to disclose that he or she wants to be designated as a member of that political party or participate in the local community events. Even after self-certifying and requesting the receipt or further reading of the supplemental data about the Republican party, the mail recipient has the additional advantage of being able to continue to receive supplemental communication via the Internet that is updated with more current data and/or event listings whenever the RFID label 5 is re-read by the recipient's client computer. Hence, there are advantages to not only supplement the mailing data initially, but to allow for continual updates though the system capabilities to read the RFID label and access updated appended data enabled in real time through the Internet.

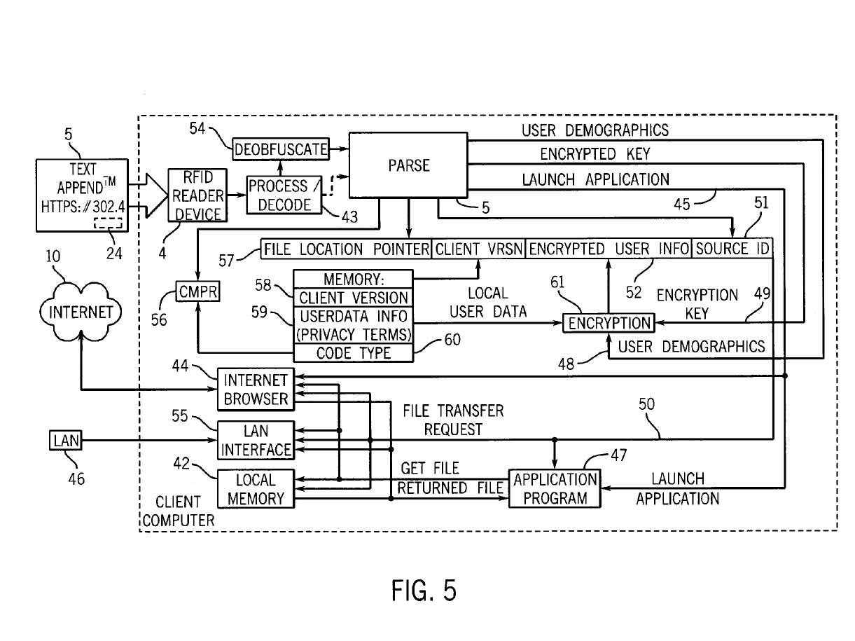

FIG. 5 illustrates that when the mailed object is received by the recipient, a person at the location, after reading the text and graphics on the document, can decide to access the Web site of the vendor by connection with a radio frequency-reader device 41 in conjunction with his client computer 42, programmed with appropriate software to utilize a Browser program such as Microsoft Internet Explorer or in accordance with the invention. That is, the user will read the code 28 with radio frequency-reader device.

After the tag reading device 41 receives the radio frequency data, a decoder 43 is used to decode the raw data into usable commands and data. The decoder is typically a software program executed by the microprocessor of the computer, and provides thereby to an Internet browser 44 the URL that had been encoded by the vendor into the RFID label 5. The browser 44 application is then loaded 47 (if not already running on the computer) by the launch command, and the URL is used to access the Web site of the vendor accordingly at the target server computer 45 via the Internet 44 or LAN 46. As a result, the user may automatically access the sender's Web site with supplemental appended data to obtain a computer file therein without having to enter the URL by a keyboard, thus eliminating all chances of error due to manual data input and providing confirmation of contractual terms regarding privacy terms. The requested file is obtained from file storage and generation means 48, and sent to the client computer via the Internet for encryption key 49 and code type 60 to display encryption 61 to the user on the browser 44 so it can be read by the recipient or/or printed out from local computer memory.

The above scenario is useful when a sender prints and distributes such intelligent documents on a mass scale. That is, the symbol 5 distributed is the same for each user. In an alternative embodiment, specific identification information is included with the code for file transfer request 50 using source ID 51 to provide for encrypted user info 52 that is parsed 53 to receive the personalized self-certified operation as follows. This scenario is useful when the vendor makes individual appended text or graphics keyed to individual users, such as when preprinted RFID labels are printed for inclusion on an envelope or box surrounding the mailed object. In this case, the sender may include in the user identification field 48 personal data such as the user's name, location, phone number, and other appropriate supplemental communication and identification information.

The code may also include security information useful in completing secure transfers across the Internet after it is de-obfuscated 54 by LAN interface 55 with the data compared 56 to file location pointer 57, using client version 58 memory under user data privacy terms 59 and code type 60. For example, an encryption key 49 appropriate in a public or private key system may be embedded within the symbol 24. The target server computer can match the source identifier string 51 sent with the transmission with the appropriate decryption key stored in a lookup table at the target server or on an external computer, and decrypt the data access detail to display the encrypted user information 61.

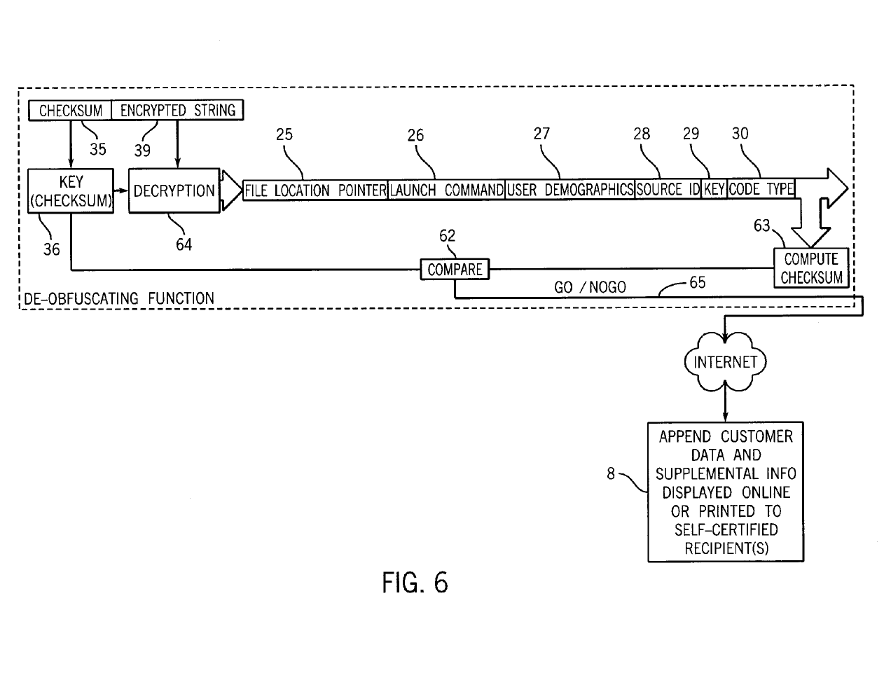

FIG. 6 is an illustration of the obfuscation function of the present invention. Prior to being encoded, the identification data string may optionally be obfuscated in order to enable the privacy related security aspects of the system. The identification data string is input into a checksum computing means 62, which then computes the checksum of the symbol data string 35 in accordance with teachings well known in the prior art. The computed checksum is then used as a key in an encryption scheme 63 which may be one of several well-known encryption methodologies known in the prior art. The key 36 is assembled in the clear (i.e., unencrypted) along with the encrypted symbol data string into by the encoding function to decrypt 64 the appended data. After this encrypted data string and cleared checksum data is encoded and compared 62, it is rendered by a go/no go step 65 with methods well known in the art and the intelligent document is thereby generated 8 through a browser connection over the Internet.

The radio frequency ID data is decoded by means well known in the art. Once the symbol data has been decoded, it is de-obfuscated (if the original symbol data had been obfuscated as described above) by de-obfuscation function 64 that is illustrated in detail in FIG. 6. First, the clear checksum 36 is utilized as a key to decryption function 64 to decrypt the encrypted string. The decryption function 97 that was preloaded onto the client computer as part of an initialization process with the system is a corollary to the encryption function 39. By passing the checksum 36 in the clear and utilizing it as the key, it enables the client computer and document generation computing means to be synchronous with respect to the encryption methodology. After the decryption function 64 produces the clear data string comprising the original file location pointer 25, launch command 26, user demographics 27, source ID 28, key 29 and code type 30, then the checksum computing means 63 operates to compute a checksum of those fields. That computed checksum is then compared by comparison block 62 with the received clear checksum 36 that was decoded by the decoding process 63. If the comparison process 62 indicates that the computed checksum equals the received clear checksum, then go/no go signal 65 indicates that the data transmission and decryption process was successful. If, however, the checksums are not favorably compared, then the go/no go signal 65 will indicate an unsuccessful transmission and decryption process. If this is unsuccessful, then further processing is aborted.

Once the symbol data is de-obfuscated, it is then parsed the browser is provided with the file transfer request and is optionally started by the launch command in the received string. At step 8, the file transfer request is transmitted to the target server, preferably in the preferred embodiment over the Internet to obtain the requested file for viewing. Naturally, the present invention is not limited to the embodiment described and represented but may have numerous variants that are accessible to those skilled in the art without departing from the spirit of the invention.

What is claimed is:

1. The application of a radio-frequency identification (“RFID”) transponder onto the outer addressable surface of a mailing piece to enable an information disclosure system that grants access to privacy protected correspondence with a contractually bound, permission-based method for the retrieval of supplemental text, data and images directly associated with the postage-paid letter or package placed in the U.S. Mail.

2. The method according to claim 1, for creating and managing postal customer relationships among sender and receiver of physical letter or package mail sent between contracting parties under a privacy standard, said contracting parties comprising (1) “covered entities” representing postal customers creating, using, and disclosing private data between themselves in the ordinary course of business, and (2) enrolled self-certified mail recipients requiring the multilateral use of said private data, said method comprising the steps of: (a) assigning digital identities to the contracting parties; (b) providing a postal customer non-negotiable terms requiring observation of said privacy standard with respect to said private data of a mail recipient partner; (c) providing a wireless RFID electronic interface accessible to said digital identities to facilitate negotiating and entering binding postal customer agreements among at least one of said covered entities pursuant to the terms of said privacy standards template; and (d) storing said postal contractual agreements in a standards database, accessible among sender and recipient of mail by computer server.

3. The method according to claim 2, wherein said electronic interface includes application of a non-reusable RFID transponder label (“Smart Label”), the size of a traditional U.S. Postage Stamp (i.e., no larger than 2″ wide by 1½″ high), with the means for incorporating wireless RFID technology into a printed label to electronically confirm and grant the access rights and permissions to disclose additional private appended data with respect to an envelope, postcard or package mailed through U.S. Postal Service (“USPS”) or other parcel and postal distribution networks.

4. Method for creating and managing postal customer relationships between contracting parties under a data append disclosure policy said contracting parties comprising (1) postal customers receiving data of customers and creating, using, and disclosing private data of such customers in the ordinary course of business, and (2) enrolled self-certified partners requiring the use of said private data, said method comprising the steps of: (a) assigning digital identities to the contracting parties; (b) providing a postal customer RFID label having non-negotiable terms requiring observation of said data append with respect to said private data of a customer; (c) providing self-certification procedures for contracting parties to certify adherence to said data append as self-certified covered entities or as self-certified business associates; (d) providing an electronic interface accessible to said digital identities to facilitate negotiating and entering binding postal customer agreements between at least one of said self-certified covered entities and a plurality of said self-certified business associates pursuant to the terms of said RFID standards template; and (e) storing said postal customer agreements in a registration and standards database, accessible among sender and recipient of mail by computer server.

5. The method according to claim 4, wherein said self-certification procedures comprise the additional steps of: providing a self-certification standard registration template for self-certification by electronic signature; and storing registrations corresponding to said template in a separate self-certification database.

6. The method according to claim 4, wherein said self-certification database access procedure includes the application of a privacy encryption format and template, in said RFID standards, to permit supplemental information access or disclosures between mail sender and mail recipient.

7. The method according to claim 4, wherein said electronic interface includes wireless data reading and updating the memory of an RFID tag to annotate and update stored digital identity to permit access to additional terms with respect to use or disclosure of said supplemental private data.

8. The method according to claim 4, wherein said interactive means includes means for a covered entity to offer and for a business associate or other mailing recipient to accept said non-negotiable terms in the RFID standards.

9. The method according to claim 4 including the additional step of: accessing a selected postal customer agreement in said RFID standards database for permission to disclose selected private data to a selected self-certified business associate or mail sending party.

10. The method according to claim 4, wherein said electronic interface includes TCP/IP (“Transmission Control Protocol/Internet Protocol”) connectivity utilizing RFID reader connected to Web browser program such as Microsoft Internet Explorer for on-screen viewing or printing by mail recipient.

11. Method for creating and managing postal customer relationships between contracting parties under a protected data policy access method, said contracting parties comprising (1) postal customers receiving data of customers and creating, using, and disclosing selected and USPS or other industry certified standards data of such customers in the ordinary course of business, and (2) enrolled self-certified partners requiring the use of said selected and USPS or other industry certified standards data, said method comprising the steps of: (a) assigning digital identities to the contracting parties; (b) providing a postal customer RFID label having non-negotiable terms requiring observation of said data append format with respect to said selected and USPS or other industry certified standards data of a customer; (c) providing a self-certification standard registration template for contracting parties to certify adherence to said data append as self-certified covered entities or as self-certified business associates by electronic signature so as to achieve self-certification; (d) storing registrations corresponding to said template in a separate self-certification database; (e) providing an electronic interface accessible to said digital identities, said electronic interface being selectively connectable to the self-certification database to facilitate negotiating and entering binding postal customer agreements between at least one of said self-certified covered entities and a plurality of said self-certified business associates pursuant to the terms of said registrations and said RFID standards template; and (f) storing said postal customer agreements in an RFID registration and standards database accessible by computer server access.

12. The method according to claim 11, wherein said interactive means includes means for a covered entity to offer and for a business entity or consumer to contractually accept said non-negotiable terms in the RFID standards.

13. The method according to claim 11, wherein said electronic interface comprises the Internet or signed written contractual means for negotiating the additional terms with respect to use or disclosure of selected USPS or mailing industry certified standards and/or information privacy disclosure data.

14. The method according to claim 11 including the additional step of: accessing a selected postal customer agreement in said RFID standards database for permission to disclose selected contents or other industry certified standards data to a selected self-certified business associate or mailing recipient.

15. The method according to claim 11, wherein said electronic interface comprises an RFID reader connected to a PC or Internet Browser terminal to enable access to the private disclosure information contained within the RFID or linked by TCP/IP methods from RFID label applied to the surface of a specific physical mailing.

16. Method of claim 15, wherein the RFID tag reading step by recipient of sent mail triggers a return e-mail reply message to the sender to confirm the day and time supplemental private information was accessed and disclosed.

17. The methods in claims 1-16 wherein methods and application systems specifically exclude integration with U.S. Postage Stamp or U.S. postage payments so as to remain independent of the U.S. Postal Services, with USPS not maintaining individual customer data other than as part of the self-certification process or as necessary to regulate or enforce compliance under U.S. Postal Regulations.
